(19) United States
(12) Patent Application Publication
(10) Pub. No.: US 2026/0200067 A1
(43) Pub. Date: Jul. 16, 2026

(54) MAGNETIC TOOL HOLDER

(71) Applicant: OAV EQUIPMENT AND TOOLS, INC., Taichung City (TW)

(72) Inventor: WEN-LUNG PAI, Taichung City (TW)

(21) Appl. No.: 19/016,924

(22) Filed: Jan. 10, 2025

(51) Int. Cl. B25H 3/02; B65D 25/22; B65D 25/24; B25H 7/04

(52) U.S. Cl. CPC B25H 3/022; B65D 25/22; B65D 25/24; B25H 7/04

(57) ABSTRACT

The present invention relates to a magnetic tool holder, including: a main body, at least one magnetic member and at least one anti-slip member. The main body includes a fixing surface and a plurality of grooves, the fixing surface is configured to face toward a mounting surface, and the plurality of grooves are configured to receive at least one object and have at least three different specifications. The at least one magnetic member is disposed on the fixing surface and configured to be magnetically attached to the mounting surface. The at least one anti-slip member is disposed on the fixing surface and configured to be abutted against and between the fixing surface and the mounting surface. Therefore, the magnetic tool holder can hold the at least one object and be easily moved to provide a convenient tool management effect.

### BACKGROUND OF THE INVENTION

### Field of the Invention

The present invention relates to a magnetic tool holder.

### Description of the Prior Art

When operating woodworking machinery, such as edge trimmers, saws, etc., operators often need to use measuring tools and marking tools to confirm cutting positions. They may also need to use small tools like utility knives or replacement parts to facilitate processing. However, in such working environments, there is often lack of places to store or place small tools. As a result, operators must carry the necessary tools with them, which is inconvenient for immediate access and tool management, leading to a decrease in work efficiency. Existing fixed storage boxes also suffer from poor mobility, reducing their practicality.

The present invention is, therefore, arisen to obviate or at least mitigate the above-mentioned disadvantages.

### SUMMARY OF THE INVENTION

The main object of the present invention is to provide a magnetic tool holder, which is movable flexibly and provides convenient tool management.

To achieve the above and other objects, the present invention provides a magnetic tool holder, including: a main body, at least one magnetic member and at least one anti-slip member. The main body includes a fixing surface and a plurality of grooves, the fixing surface is configured to face toward a mounting surface, and the plurality of grooves are configured to receive at least one object and have at least three different specifications. The at least one magnetic member is disposed on the fixing surface and configured to be magnetically attached to the mounting surface. The at least one anti-slip member is disposed on the fixing surface and configured to be abutted against and between the fixing surface and the mounting surface.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1-3 are stereograms of a preferable embodiment of the present invention in different perspective views;

FIG. 4 is a breakdown drawing of a preferable embodiment of the present invention;

FIG. 5 is a cross-sectional view of a preferable embodiment of the present invention in use;

FIG. 6 is a drawing showing operation of a preferable embodiment of the present invention; and

FIG. 7 is a side view of FIG. 6

### DETAILED DESCRIPTION OF THE PREFERRED EMBODIMENTS

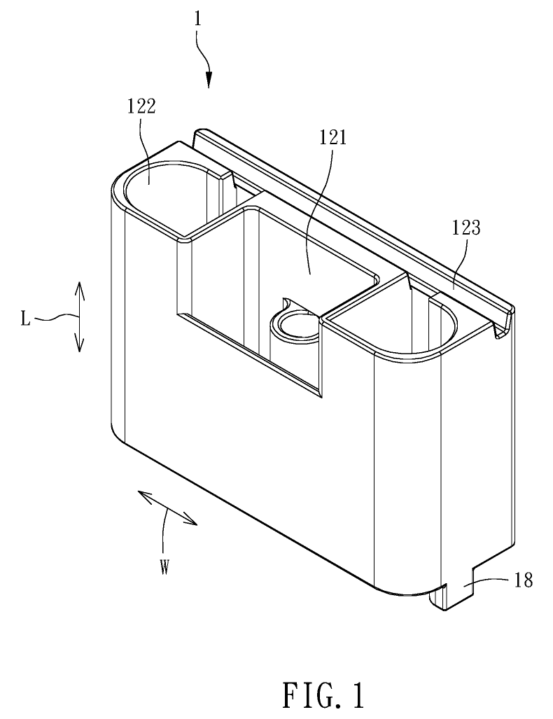

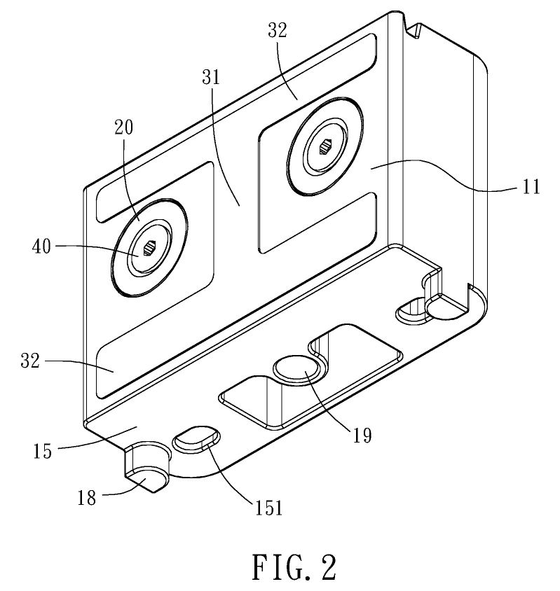

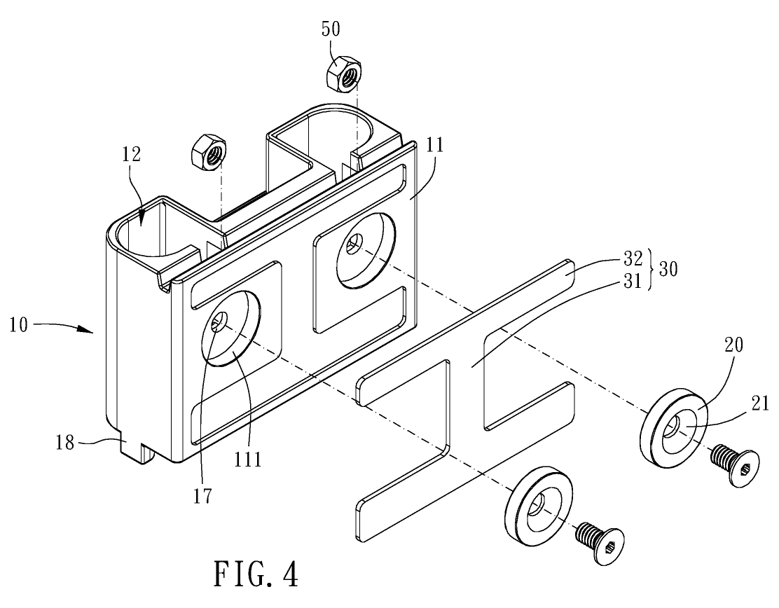

Please refer to FIGS. 1 to 7 for a preferable embodiment of the present invention. A magnetic tool holder 1 of the present invention includes a main body 10, at least one magnetic member 20 and at least one anti-slip member 30.

The main body 10 includes a fixing surface 11 and a plurality of grooves 12, the fixing surface 11 is configured to face toward a mounting surface 2, and the plurality of grooves 12 are configured to receive at least one object and have at least three different specifications. The at least one magnetic member 20 is disposed on the fixing surface 11 and configured to be magnetically attached to the mounting surface 2. The at least one anti-slip member 30 is disposed on the fixing surface 11 and configured to be abutted against and between the fixing surface 11 and the mounting surface 2. The plurality of grooves 12 may differ from one another in sizes, shapes, or opening directions so as to receive different types of said objects and achieve convenient tool management. The magnetic tool holder 1 is movable to the desired position as needed, such as being attached to different locations on a woodworking machine or other metal surfaces that can be magnetically attracted. It is not easily displaced and provides excellent mobility, effectively improving work efficiency, while also preventing tools from being scattered and enhancing the safety of the work environment.

Preferably, the main body 10 further includes a top surface 14 and a bottom surface 15 opposite to each other, the plurality of grooves 12 are at least partially open outward from the top surface 14, and the bottom surface 15 has at least one communication hole 151 disposed thereon. Each of the at least one communication hole 151 is communicated with one of the plurality of grooves 12 so that sawdust or other processing fragments can be removed from the plurality of grooves 12.

Specifically, the plurality of grooves 12 include at least one first groove 121 and at least one second groove 122 which extend in a longitudinal direction L, and a cross sectional profile of each of the at least one first groove 121 is different in shape from a cross sectional profile of each of the at least one second groove 122. In this embodiment, the plurality of grooves 12 include one said first groove 121 and two said second grooves 122 located at two opposite sides of the said first groove 121. The cross sectional profile of the said first groove 121 is in a rectangular shape, and the cross sectional profile of each of the two said second grooves 122 is in an arched shape. The main body 10 further includes a front surface 13 opposite to the fixing surface 11, and the front surface 13 has at least one notch 131 communicated with the plurality of grooves 12 (the said first groove 121, in this embodiment) and configured to hang the at least one object. The said first groove 121 extends through the main body 10 so as to engage a tool with an expanding head, such as a screwdriver, chisel, etc., and a tape measure may be hung on a portion of the front surface 13 with the at least one notch 131. Each of the two said second grooves 122 is configured to receive pens, rod-shaped tools, straightedges so as to meet different requirements. In other embodiments, the numbers and shapes of said first grooves and said second grooves are changeable to meet different requirements; and the front surface may be configured without the notch.

The plurality of grooves 12 further include at least one third groove 123, and each of the at least one third groove 123 extends in a lateral direction W transverse to the longitudinal direction L and penetrates through the main body 10. A depth of each of the at least one third groove 123 in the longitudinal direction L is smaller than a depth of the said first groove 121 and a depth of each of the two said second grooves 122, and the at least one third groove 123 may be used to receive steel squares or straightedges. Preferably, the at least one third groove 123 is located between the said first groove 121 and the fixing surface 11, which prevents said objects placed on the at least one third groove 123 from being interfered with said objects placed on the said first groove 121 and the two said second grooves 122. In other embodiments, each said third groove may be arranged in other positions to meet different requirements.

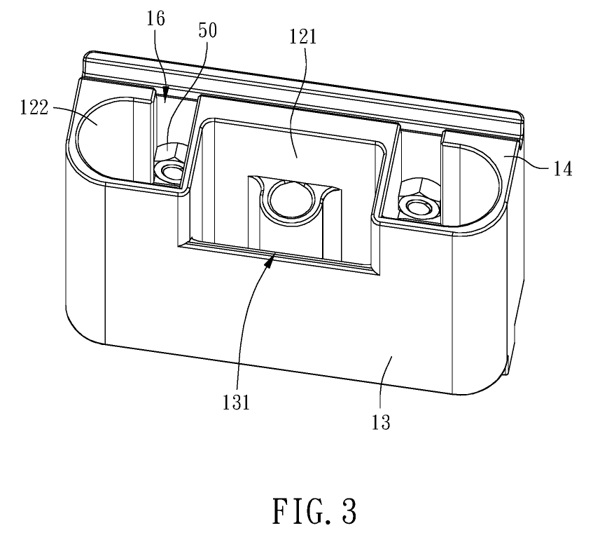

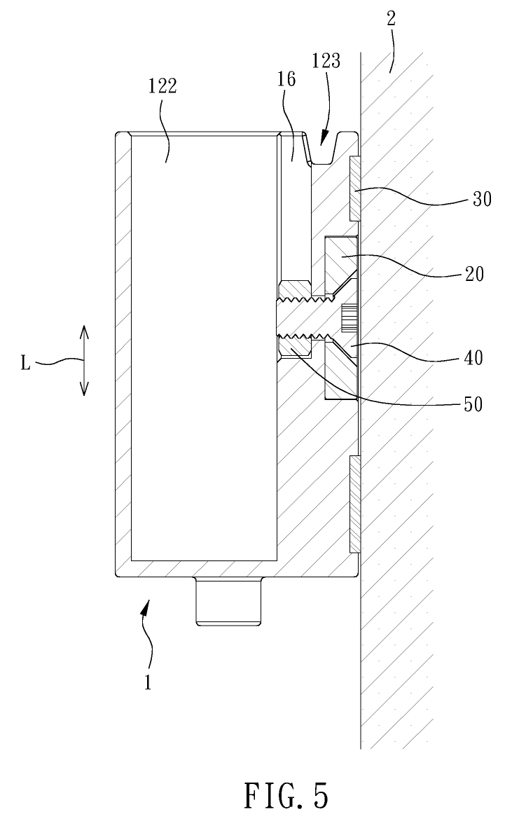

Preferably, each of the at least one magnetic member 20 is a neodymium magnet, such as a N42 neodymium magnet, which has strong magnetic force and excellent load-bearing capacity. Moreover, the magnetic tool holder 1 further includes at least one screw 40 and at least one nut 50, and the main body 10 further includes at least one restriction slot 16 and at least one through hole 17. The at least one through hole 17 extends between the at least one restriction slot 16 and the fixing surface 11, each of the at least one nut 50 is non-rotatably received within one of the at least one restriction slot 16, and each of the at least one screw 40 penetrates through one said magnetic member 20 and one said through hole 17 and is screwed to one said nut 50, as shown in FIGS. 3 and 5. In assembling, each said nut 50 is abuttable against two opposite sidewalls of one said restriction slot 16, which is convenient for assembling, and the at least one screw 40 is not easily loosen from the at least one nut 50. Each of the at least one restriction slot 16 is open toward the top surface 14 and one of the two said second grooves 122, which is convenient to place and secure the at least one nut 50.

In this embodiment, the fixing surface 11 has at least one embedded groove 111 recessed thereon, and the at least one magnetic member 20 is received within the at least one embedded groove 111. Each of the at least one magnetic member 20 has a recessed opening 21, and a head portion of each of the at least one screw 40 is received within one said recessed opening 21. The at least one magnetic member 20 and the at least one screw 40 preferably non-protrude beyond the fixing surface 11 so as to avoid collisions and abrasion with the mounting surface 2.

The at least one anti-slip member 30 partially protrudes beyond the fixing surface 11 and includes at least one first extension segment 31 and at least one second extension segment 32 lateral to the at least one first extension segment 31. Each of the at least one first extension segment 31 extends in the longitudinal direction L, and each of the at least one second extension segment 32 extends in the lateral direction W, respectively providing frictional resistance in the longitudinal direction L and the lateral direction W, thereby providing preferable load-bearing capacity for the magnetic tool holder 1. In this embodiment, the magnetic tool holder 1 includes one said anti-slip member 30 in H-shaped, and the said anti-slip member 30 is integrally molded with the main body 10 as one piece by injection molding so that the said anti-slip member 30 and the main body 10 are not easily departed from each other. Preferably, a width of one said second extension segment 32 close to the bottom surface 15 is larger than a width of one said second extension segment 32 close to the top surface 14 so as to effectively improve anti-slip effect. A width that the at least one anti-slip member 30 protruding beyond the fixing surface 11 is between 0.3 mm and 0.8 mm, which prevents the main body 10 or the at least one magnetic member 20 from being collided directly with the mounting surface 2 when the magnetic tool holder 1 is attached to the mounting surface 2. Each of the at least one anti-slip member 30 has a Shore hardness in a range of A20 to A50 (preferably between A30 and A40), and the at least one anti-slip member 30 may be made of an elastomer so as to provide cushioning and anti-slip effects and protect the mounting surface 2 from being scratched.

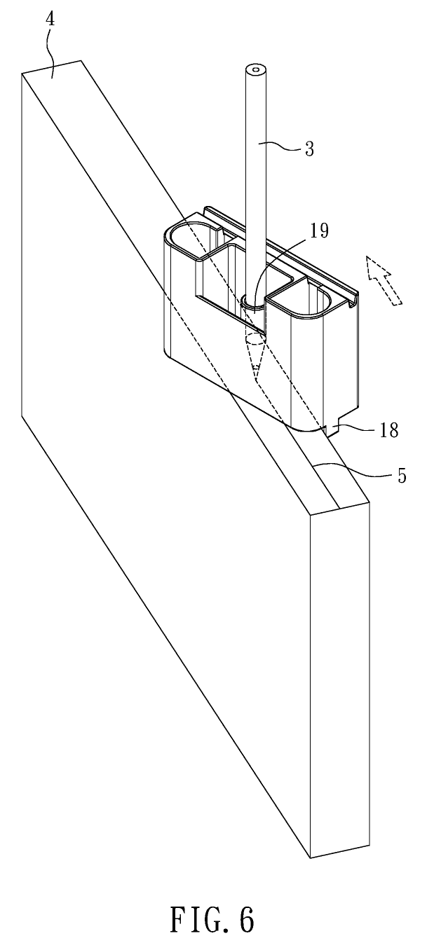

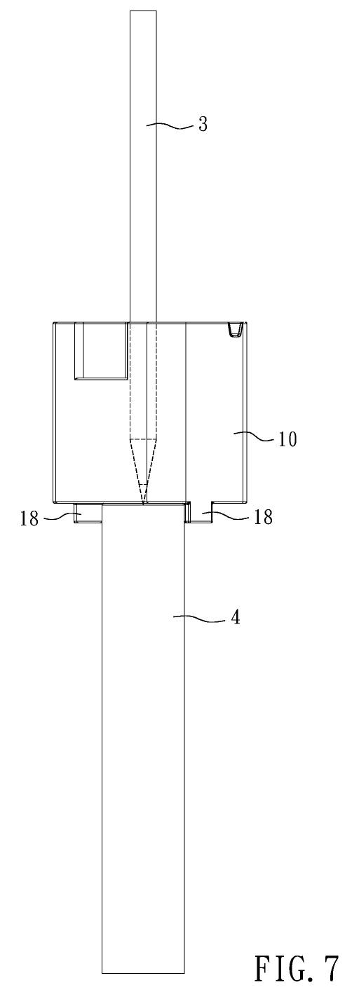

The main body 10 further includes two abutting projections 18 spaced apart from each other and an insertion slot 19 configured to receive a drawing tool 3, and the insertion slot 19 is located between the two abutting projections 18. When the two abutting projections 18 are abutted against two opposite sides of a board member 4 and the main body 10 is moved along the board member 4, the drawing tool 3 is configured to draw a line 5 on the board member 4, as shown in FIGS. 6 and 7. Therefore, the magnetic tool holder 1 can be used as a drawing tool and is multifunctional and convenient. In this embodiment, the two abutting projections 18 are disposed on the bottom surface 15, and the insertion slot 19 is located within the first groove 121 and at a middle of the two abutting projections 18. When the two abutting projections 18 are abutted against two opposite sides of the board member 4 in a thickness direction, the drawing tool 3 is positioned at a center of the board member 4, allowing for the drawing of a center line of the board member 4.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A magnetic tool holder, including:
a main body, including a fixing surface and a plurality of grooves, the fixing surface configured to face toward a mounting surface, the plurality of grooves configured to receive at least one object and having at least three different specifications;
at least one magnetic member, disposed on the fixing surface and configured to be magnetically attached to the mounting surface; and
at least one anti-slip member, disposed on the fixing surface and configured to be abutted against and between the fixing surface and the mounting surface.

2. The magnetic tool holder of claim 1, wherein the plurality of grooves include at least one first groove and at least one second groove which extend in a longitudinal direction, and a cross sectional profile of each of the at least one first groove is different in shape from a cross sectional profile of each of the at least one second groove.

3. The magnetic tool holder of claim 2, wherein the plurality of grooves further include at least one third groove, and each of the at least one third groove extends in a lateral direction transverse to the longitudinal direction and penetrates through the main body.

4. The magnetic tool holder of claim 1, wherein the main body further includes a front surface opposite to the fixing surface, and the front surface has at least one notch communicated with the plurality of grooves and configured to hang the at least one object.

5. The magnetic tool holder of claim 1, wherein the main body further includes a top surface and a bottom surface opposite to each other, the plurality of grooves are at least partially open outward from the top surface, the bottom surface has at least one communication hole disposed thereon, and each of the at least one communication hole is communicated with one of the plurality of grooves.

6. The magnetic tool holder of claim 1, wherein the at least one anti-slip member partially protrudes beyond the fixing surface and includes at least one first extension segment and at least one second extension segment lateral to the at least one first extension segment.

7. The magnetic tool holder of claim 1, wherein the at least one anti-slip member has a Shore hardness in a range of A20 to A50.

8. The magnetic tool holder of claim 1, wherein the main body further includes two abutting projections spaced apart from each other and an insertion slot configured to receive a drawing tool, the insertion slot is located between the two abutting projections; when the two abutting projections are abutted against two opposite sides of a board member and the main body is moved along the board member, the drawing tool is configured to draw a line on the board member.

9. The magnetic tool holder of claim 1, further including at least one screw and at least one nut, wherein the main body further includes at least one restriction slot and at least one through hole, the at least one through hole extends between the at least one restriction slot and the fixing surface, each of the at least one nut is non-rotatably received within one of the at least one restriction slot, and each of the at least one screw penetrates through one said magnetic member and one said through hole and is screwed to one said nut.

10. The magnetic tool holder of claim 3, wherein the cross sectional profile of each of the at least one first groove is in a rectangular shape, the cross sectional profile of each of the at least one second groove is in an arched shape; the plurality of grooves include one said first groove and two said second grooves located at two opposite sides of the said first groove, the at least one third groove is located between the said first groove and the fixing surface, a depth of each of the at least one third groove in the longitudinal direction is smaller than a depth of the said first groove and a depth of each of the two said second grooves; the main body further includes a front surface opposite to the fixing surface, and the front surface has at least one notch communicated with the plurality of grooves and configured to hang the at least one object; the main body further includes a top surface and a bottom surface opposite to each other, the plurality of grooves are at least partially open outward from the top surface, the bottom surface has at least one communication hole disposed thereon, and each of the at least one communication hole is communicated with one of the plurality of grooves; each of the at least one magnetic member is a N42 neodymium magnet; the main body further includes two abutting projections spaced apart from each other and an insertion slot configured to receive a drawing tool, the insertion slot is located between the two abutting projections; when the two abutting projections are abutted against two opposite sides of a board member and the main body is moved along the board member, the drawing tool is configured to draw a line on the board member; the two abutting projections are disposed on the bottom surface, the insertion slot is located within the said first groove and at a middle of the two abutting projections; the fixing surface has at least one embedded groove recessed thereon, the at least one magnetic member is received within the at least one embedded groove; the magnetic tool holder further includes at least one screw and at least one nut, the main body further includes at least one restriction slot and at least one through hole, the at least one through hole extends between the at least one restriction slot and the fixing surface, each of the at least one nut is non-rotatably received within one of the at least one restriction slot, and each of the at least one screw penetrates through one said magnetic member and one said through hole and is screwed to one said nut; each of the at least one restriction slot is open toward the top surface and one of the two said second grooves; each of the at least one magnetic member has a recessed opening, a head portion of each of the at least one screw is received within one said recessed opening; the at least one anti-slip member partially protrudes beyond the fixing surface and includes at least one first extension segment and at least one second extension segment lateral to the at least one first extension segment, each of the at least one first extension segment extends in the longitudinal direction, each of the at least one second extension segment extends in the lateral direction; a width of one said second extension segment close to the bottom surface is larger than a width of one said second extension segment close to the top surface; a width that the at least one anti-slip member protruding beyond the fixing surface is between 0.3 mm and 0.8 mm; the at least one anti-slip member has a Shore hardness in a range of A30 to A40; and the magnetic tool holder includes one said anti-slip member in H-shaped, and the said anti-slip member is integrally molded with the main body as one piece by injection molding.
